(19) United States
(12) Patent Application Publication
(10) Pub. No.: US 2026/0348864 A1
(43) Pub. Date: Nov. 5, 2026

(54) PROCESS FOR NON-DESTRUCTIVE QUALITY CONTROL OF A PART FORMED OF A NICKEL-BASED SUPERALLOY

(71) Applicant: SAFRAN, Paris (FR)

(72) Inventor: Cécile BRUTT, Moissy-Cramayel (FR)

(73) Assignee: SAFRAN, Paris (FR)

(21) Appl. No.: 19/486,791

(22) PCT Filed: May 22, 2024
(86) PCT No.: PCT/EP2024/064104

§ 371 Date: Nov. 21, 2025

(30) Foreign Application Priority Data
May 24, 2023 (FR) FR2305114

(51) Int. Cl. G01N 21/88; G01N 21/958

(52) U.S. Cl. CPC G01N 21/8806; G01N 21/958; G01N 2021/8848

(57) ABSTRACT

A process for inspecting a part, which process is implemented in an optical system configured to analyse parts of birefringent major phase, is proposed. The process includes emitting an incident beam towards a surface of the part, linearly polarising the incident beam along a first polarisation axis and transmitting a polarised incident beam onto the surface, linearly polarising the reflected beam, resulting from the reflection of the polarised incident light beam by the surface, along a second polarisation axis perpendicular to the first axis, and transmitting a polarised reflected beam, obtaining an image representative of reflections on the surface, determining whether at least one area, referred to as “light area”, of the image has a luminous intensity greater than a predefined threshold, and detecting a defect when the light area satisfies a predefined geometric criterion.

### TECHNICAL FIELD

The present invention relates to the field of non-destructive testing, and more particularly to a process for inspecting the surface of a part comprising a non-birefringent major phase, which process is implemented in an optical system.

### BACKGROUND ART

Parts composed of a material comprising a non-birefringent major phase such as for example a nickel-based superalloy are frequently used in the aeronautical sector for their thermomechanical properties. Now, such nickel-based superalloy parts are generally manufactured using forging and/or machining techniques which may cause microstructural defects to form. Such defects comprise undesirable phases, of a different chemical composition from the composition of the major phases of the parts, owing to chemical segregation. The defects thus produced embrittle the microstructure of the parts and lead to a reduction in the lifespan of such parts.

It is therefore necessary to detect the presence of such defects on the surface of the nickel-based superalloy parts. One method commonly used for detecting defects is macrography, which requires a prior chemical treatment step to be carried out on the surface by etching in order to reveal the microstructure of the part. The defects then appear as black or white spots and can be detected by an operator. However, macrography is slow and complex owing to the need for the prior chemical treatment step, and furthermore requires the use of harmful chemicals.

Electron backscatter diffraction (EBSD) enables the crystallographic orientation of a microstructure to be analysed and different phases present in the microstructure to be indexed. Such a method, however, requires the use of a scanning electron microscope, and this requires performing measurements in a vacuum and involves analysing samples of several cm² at most. Furthermore, the samples have to be polished, and measurements are particularly slow since it takes several hours to analyse a surface of the order of one cm². Local chemical analysis methods such as energy-dispersive X-ray spectroscopy (EDS) have similar drawbacks. Such methods are therefore not suitable for checking for defects on an industrial scale, in a quick and simple manner.

It is therefore desirable to overcome these drawbacks of the prior art.

It is in particular desirable to provide a solution for non-destructive testing of the surface of a part composed of a material comprising a non-birefringent major phase such as for example a nickel-based superalloy in order to detect the presence of microstructural defects comprising undesirable phases. It is furthermore desirable to provide an inspection solution which does not require a prior treatment or preparation step. Finally, it is desirable to provide a solution which is quick and can be applied to surfaces of large dimensions.

### DISCLOSURE OF THE INVENTION

A process for quality control of a part to be inspected, the control process being able to be implemented in an optical inspection system configured to analyse parts having a birefringent major phase, is proposed here. The process is intended to determine whether the material of the part comprises at least one birefringent minor phase representative of a defect, and comprises: emitting an incident light beam in the direction of a surface of the part to be inspected; linearly polarising the incident light beam along a first polarisation axis so as to transmit a polarised incident light beam onto the surface of the part to be inspected; linearly polarising the reflected light beam along a second polarisation axis oriented perpendicularly to the first polarisation axis so as to transmit a polarised reflected light beam, the reflected light beam (103) resulting from the reflection of the polarised incident light beam (102) by the surface (100) of the part (10); obtaining an image representative of reflections on the surface of the part; determining whether at least one area of the image has a luminous intensity greater than a predefined threshold, said area of the image being referred to as “light area”; and detecting a defect when at least one light area of the image satisfies a predefined geometric criterion.

Thus it is easy to detect the presence of birefringent minor phases representative of defects and thus to detect the presence of defects, non-destructively and without any prior treatment step. Furthermore, the contrast obtained between those areas of the image which are representative of the major phase and those areas of the image which are representative of the birefringent minor phases makes it possible to simplify and improve the reliability of the detection of defects by optical observation. It is thus easy to detect defects in a part formed of a nickel-based superalloy, without a prior chemical treatment step.

According to one particular embodiment, the predefined geometric criterion comprises the light area comprising at least one extent greater than a predefined value.

According to one particular embodiment, the predefined value is equal to 100 μm.

Thus it is easy to detect defects of freckle type in a part formed of nickel-based superalloy, while considering δ and γ″ phases as being not representative of defects.

According to one particular embodiment, the predefined geometric criterion comprises the light area having a surface larger than a predefined area.

According to one particular embodiment, the control process furthermore comprises recording the image of the surface of the part obtained, and transmitting said image of the surface to a processing device comprising electronic circuitry configured to implement the steps of determining whether at least one area of the image has a luminous intensity greater than a predefined threshold and detecting a defect when at least one light area of the image satisfies a predefined geometric criterion.

It is thus possible to carry out automatic detection of defects on the surface of the part.

There is also proposed an optical inspection system intended for inspecting the quality of a part formed of a material comprising a non-birefringent major phase, the optical inspection system being configured to analyse parts having a birefringent major phase, the optical inspection system being intended to determine whether the material comprises at least one birefringent minor phase representative of a defect. The optical inspection system comprises: a light source configured to emit an incident light beam in the direction of a surface of the part to be inspected; a polariser configured to linearly polarise the incident light beam along a first polarisation axis so as to transmit a polarised incident light beam onto the surface of the part to be inspected; a second polariser, referred to as “analyser”, configured to linearly polarise a reflected light beam along a second polarisation axis oriented perpendicularly to the first polarisation axis so as to transmit a polarised reflected light beam, the reflected light beam resulting from the reflection of the polarised incident light beam by the surface of the part; an optical device for forming an image representative of reflections on the surface of the part; means for determining whether at least one area of the image has a luminous intensity greater than a predefined threshold, referred to as “light area”; and means for detecting a defect when at least one light area of the image satisfies a predefined geometric criterion.

According to one particular embodiment, the defect is a defect of freckle type.

According to one particular embodiment, the minor phase representative of a defect is an η phase, a μphase, a σ phase, a Laves phase and/or a boride.

### BRIEF DESCRIPTION OF THE DRAWINGS

The characteristics of the invention mentioned above, and others, will become more clearly apparent on reading the following description of at least one example of embodiment, said description being given in relation to the appended drawings, in which:

FIG. 1 illustrates schematically an optical inspection system in which a process for the quality control of a part is implemented; and

FIG. 2 illustrates schematically the process for the quality control of the part.

### DETAILED DESCRIPTION OF EMBODIMENTS

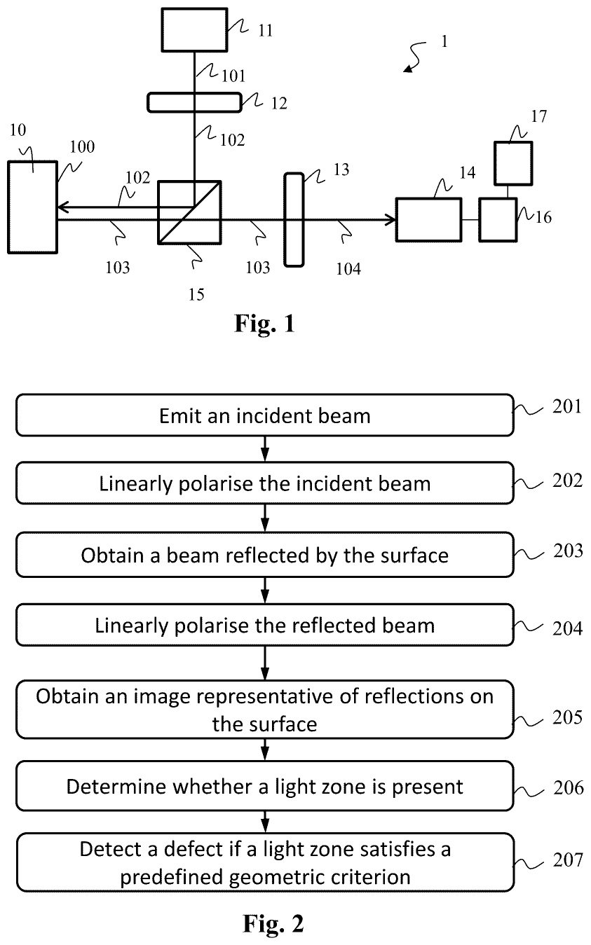

FIG. 1 thus illustrates schematically an optical inspection system 1 in which a process for the quality control of a part 10 is implemented. The part 10 to be inspected is formed of a material comprising a major crystalline phase which is non-birefringent, in other words a major crystalline phase which is optically isotropic and has an identical refractive index in all the directions of the crystal. In the material forming the part 10, one crystalline phase is distinguished from another crystalline phase by its crystalline structure and/or by its composition, in other words by the proportions of chemical elements constituting it. The major crystalline phase of the part 10 is a phase which is present over more than 80% of a surface 100 of the part 10.

Preferably, the material forming the part 10 to be inspected is a nickel-based superalloy which comprises a γ phase matrix, the γ phase being the major phase of the part 10. The γ phase matrix has a crystalline structure belonging to the cubic-type crystal system and is non-birefringent. According to one example, the nickel-based superalloy furthermore comprises the γ′ phase which is not representative of defects and is non-birefringent, and the combination of γ and γ′ phases is then present over more than 80% of a surface 100 of the part 10 and is considered as the major phase of the part 10. Alternatively, the nickel-based superalloy furthermore comprises a δ phase and a γ″ phase which are birefringent and not representative of defects. In this case, the γ phase is present over more than 80% of a surface 100 of the part 10 formed of nickel-based superalloy.

Furthermore, the nickel-based superalloy may comprise birefringent minor phases which include precipitates such as borides, an η phase, a μphase, a σ phase and/or a Laves phase. The birefringent phases are optically anisotropic. In other words, the refractive index of said birefringent phases differs according to the crystallographic axis of the material. The presence of said birefringent minor phases on a surface 100 of the part 10 is representative of defects on said surface 100. The defects are for example undesirable phases, the presence of which adversely affects the thermomechanical properties of the part 10. The defects may furthermore be defects of freckle type, which are defects of segregation which appear when the part 10 solidifies and which comprise η-phase grains. The defects of freckle type may have a substantially elongated form with a length of several tens of micrometres, for example 100 micrometres.

The part 10 is considered to have a defect if a minor phase exhibits a predefined geometric characteristic, for example a predefined size and/or predefined form. Preferably, a minor phase is considered to be representative of a defect when said minor phase comprises at least one extent greater than a first predefined value, the first predefined value being relative to the surface 100 of the part 10. The first predefined value is for example equal to 100 μm. An extent is a one-dimensional measurement such as the length of the longest side of a portion of the surface 100 of the part 10 formed by a minor phase or such as the largest segment passing through said portion of the surface 100 of the part 10 formed by a minor phase.

When the nickel-based superalloy furthermore comprises the δ and γ″ phases, which are birefringent but not representative of defects, the δ and γ″ phases however exhibit extents smaller than the first predefined value, for example less than 100 μm.

The optical inspection system 1 is configured to analyse parts having a birefringent major phase, in other words parts formed of a material the phase of which which is present over more than 80% of a surface is birefringent.

Preferably, the optical inspection system 1 comprises a light source 11, a polariser 12, the part 10, a second polariser, referred to as “analyser” 13, and an optical image-forming device 14.

The light source 11 emits an incident light beam 101 in the direction of a surface 100 to be analysed of the part 10. Said surface 100 is oriented facing the polarised incident light beam 101.

The polariser 12 linearly polarises the incident light beam 101 along a first polarisation axis so as to transmit a polarised incident light beam 102 onto the surface 100 of the part 10. The first polarisation axis is perpendicular to the direction of propagation of the incident light beam 101 emitted by the light source 11. The polariser 12 is placed on the optical path of the incident light beam 101, between the light source 11 and the surface 100 of the part 10. The incident light beam 101 is a non-polarised light beam. Alternatively, the incident light beam 101 is a polarised beam which comprises at least one non-zero linear polarisation component in the direction of the first polarisation axis, so that the polarised incident light beam 102 has a non-zero luminous intensity.

The polarised incident light beam 102 is reflected on the surface 100 into a reflected light beam 103. Put another way, the surface 100 of the part 10 is capable of reflecting the polarised incident light beam 102 so as to send back a reflected light beam 103.

The analyser 13 linearly polarises the reflected light beam 103, along a second polarisation axis oriented perpendicularly to the first polarisation axis, so as to transmit a polarised reflected light beam 104. The second polarisation axis is furthermore perpendicular to the direction of propagation of the reflected light beam 103. The analyser 13 is placed on the optical path of the reflected light beam 103, between the surface 100 of the part 10 and the optical image-forming device 14. The analyser 13 enables those components of the reflected light beam 103 which are reflected by the minor phases to pass through at least partially, and does not allow through those components of the reflected light beam 103 which are reflected by the non-birefringent major phases.

The optical image-forming device 14 enables an image representative of reflections on the surface 100 of the part 10 to be obtained. Said image is formed from the polarised reflected light beam 104.

The image representative of reflections on the surface 100 has areas of zero luminous intensity, referred to as “dark areas”, which represent non-birefringent areas of the surface 100. The linear polarisation of the polarised incident light beam 102 received on said non-birefringent areas is not modified by reflection. Those parts of the reflected light beam 103 which are reflected by the non-birefringent areas of the surface 100 are therefore polarised linearly in the direction of the first polarisation axis of the polariser 12, and are blocked by the analyser 13 since they do not comprise any polarisation component in the direction of the second polarisation axis. No light signal is therefore detected by the optical image-forming device 14 coming from the non-birefringent areas. As the major phase of the material forming the part 10 is non-birefringent, the dark areas cover a portion of the image representing more than 80% of the surface 100.

Thus, for a part 10 formed of a nickel-based superalloy, the dark areas of the image represent areas of the surface 100 that comprise the γ major crystalline phase, and, if applicable, the γ′ phase. The dark areas of the image may furthermore represent carbides, which, by themselves, are not representative of sought defects.

The image representative of reflections on the surface 100 may furthermore have areas of a luminous intensity greater than a predefined threshold, referred to as “light areas”, which represent areas of the surface 100 which exhibit birefringence. The predefined threshold is strictly greater than zero, so that the light areas necessarily have a non-zero luminous intensity. Unlike the non-birefringent areas, the birefringent areas of the surface 100 modify the direction of polarisation upon the reflection of the polarised incident light beam 102. Thus those parts of the reflected light beam 103 which are reflected by the birefringent areas of the surface 100 comprise a non-zero polarisation component oriented in the direction of the second polarisation axis and transmitted by the analyser 13. The luminous intensity of those parts of the reflected light beam 103 which are reflected by the birefringent areas is potentially attenuated by the analyser 13, but not cancelled.

As the major crystalline phase of the material is non-birefringent, the light areas therefore represent minor phases of the material and cover a portion of the image that represents less than 20% of the surface 100. It is therefore possible readily to detect the presence and location of minor phases on the surface 100.

The surface 100 of the part 10 is considered to comprise a defect when at least one minor phase exhibits a predefined geometric characteristic. A defect is therefore detected on the surface 100 when at least one light area satisfies a predefined geometric criterion, a size or shape criterion, for example. It is thus easy to detect at least one defect on the surface when the image has at least one light area which satisfies the predefined geometric criterion.

According to one preferred embodiment, a light area is considered representative of a defect when said light area is localised and exhibits at least one dimension greater than a second predefined dimension, the extent being a first predefined dimension, the second predefined dimension being representative of the first predefined dimension on the surface 100. Said second predefined dimension, relative to the image, may be calculated as a function of the first predefined dimension and of an optical magnification of the optical image-forming device 14. Defects of freckle type can thus be easily detected.

Furthermore, the contrast between the light areas of the image, which are areas of a luminous intensity greater than the predefined threshold and therefore of a non-zero luminous intensity, and the dark areas of the image, which are areas of zero luminous intensity, makes it possible to simplify and improve the reliability of detection of defects by optical observation. According to one embodiment, the light areas can be easily distinguished from the dark areas by an image processing method of the binarisation by thresholding type starting from a histogram of the image, such as the Otsu method.

The detection of defects is thus carried out non-destructively and furthermore does not require a prior chemical treatment step. The detection of defects is simplified and accelerated compared with techniques requiring the use of such prior treatment steps. Furthermore, no use of harmful chemicals is necessary.

For a part 10 formed of a nickel-based superalloy, the light areas of the image represent areas of the surface 100 comprising minor phases which include borides, η, μ, σ and/or Laves phases, which are representative of defects.

The light areas of the image represent areas of the surface 100 which may furthermore comprise δ and γ″ phases. However, the δ and γ″ phases have dimensions smaller than the dimensions of the minor phases representative of defects, for example less than 100 μm. Thus a light area having at least one dimension greater than the second predefined dimension cannot be representative of a δ or γ″ phase.

According to one example of embodiment, the optical image-forming device 14 is configured such that the image representative of reflections on the surface 100 which is obtained is enlarged relative to the surface 100 of the part 10. The optical image-forming device 14 is for example an optical microscope. According to one example of embodiment, the optical image-forming device 14 furthermore comprises a resolution limit equal to or less than 100 micrometres, preferably equal to or less than 10 micrometres, and more preferably equal to or less than 1 micrometre. Thus the image obtained enables microstructural defects present on the surface 100 and having minimum dimensions equal to the resolution limit to be observed. Defects of freckle type having a length of 100 micrometres can then easily be observed. According to one example of embodiment, the optical image-forming device 14 is configured so as to obtain an image representing an area greater than or equal to 1 cm² of the surface 100 of the part 10. One and the same image obtained thus enables defects to be detected rapidly over an area of at least 1 cm².

According to one particular embodiment, the optical inspection system 1 comprises a beam splitter 15 configured to split the polarised incident light beam 102 from the reflected light beam 103 such that only the reflected light beam 103 is sent to the analyser 13 and then on to the optical image-forming device 14.

The optical inspection system 1 furthermore comprises an acquisition device 16. The acquisition device 16 is configured to receive the image representative of reflections on the surface 100 which is obtained by the optical image-forming device 14, and to record said image. The acquisition device is for example an optical camera.

The optical inspection system 1 furthermore comprises a processing device 17. The acquisition device 16 is configured to transmit the received and/or recorded image to the processing device 17. The processing device 17 is configured to receive the image coming from the acquisition device 16 and to apply image processing algorithms to the received image in order to detect defects. For example, the processing device 17 applies for example a method of binarisation by thresholding to the image to distinguish the dark areas from the light areas and determine whether at least one area of the image has a luminous intensity greater than the predefined intensity threshold.

The processing device 17 implements a comparison of the light areas detected with the predefined geometric criterion in order to determine whether at least one light area satisfies the predefined geometric criterion. Preferably, the processing device 17 measures the largest dimension of each detected light area and then compares said dimension with the second predefined dimension. The processing device 17 detects a defect for each detected light area of which the largest dimension is greater than the second predefined dimension. According to one embodiment, the processing device 17 receives information representative of the magnification of the optical image-forming device 14 and calculates the second predefined dimension as a function of the first predefined dimension and said magnification.

The processing device 17 comprises a processor capable of executing instructions loaded into a memory, said instructions forming a computer program implementing the image processing steps described here. All or some of the image processing steps described here can thus be implemented in software form by execution of a set of instructions by a programmable machine, for example a processor of DSP (digital signal processor) type or a microcontroller, or be implemented in hardware form by a machine or dedicated electronic component (chip) or a dedicated set of electronic components (chipset), for example an FPGA (field programmable gate array) or ASIC (application specific integrated circuit) component. Generally, the processing device 17 comprises electronic circuitry adapted and configured to implement the image processing steps described here.

FIG. 2 schematically illustrates the process for quality control of the part 10. The process is implemented in an optical inspection system 1 configured to analyse parts having a birefringent major phase. Put another way, at least one step of the process is executed by said optical inspection system 1.

In a step 201, the optical inspection system 1 emits the incident light beam 101 in the direction of a surface 100 of the part 10 to be inspected.

In a subsequent step 202, the optical inspection system 1 linearly polarises the incident light beam 101 along the first polarisation axis, so as to transmit the polarised incident light beam 102 onto the surface 100 of the part 10.

In a subsequent step 203, the optical inspection system 1 obtains the reflected light beam 103, said reflected light beam 103 resulting from the reflection of the polarised incident light beam 102 by the surface 100 of the part 10.

In a subsequent step 204, the optical inspection system 1 linearly polarises the reflected light beam along the second polarisation axis oriented perpendicularly to the first polarisation axis, so as to transmit a polarised reflected light beam 104.

In a subsequent step 205, the optical inspection system 1 obtains an image representative of reflections on the surface 100 of the part 10. The image thus obtained is formed from the polarised reflected light beam 104.

In a subsequent step 206, the process comprises determining whether at least one light area is present in the image, in other words whether at least one area of the image has a luminous intensity greater than the predefined threshold. According to one embodiment, the process comprises detecting each light area present in the image.

In a subsequent step 207, the process comprises detecting a defect when at least one light area of the image satisfies the predefined geometric criterion. Preferably, a defect is detected in each light area comprising at least one dimension greater than the second predefined dimension, in other words representative of a dimension of the surface 100 which is greater than the first predefined dimension.

1. A quality control process for a part to be inspected, the process being intended to determine whether the material of the part comprises at least one birefringent minor phase representative of a defect, the process comprising:
emitting an incident light beam in the direction of a surface of the part to be inspected,
linearly polarising the incident light beam along a first polarisation axis so as to transmit a polarised incident light beam onto the surface of the part to be inspected,
linearly polarising the reflected light beam along a second polarisation axis oriented perpendicularly to the first polarisation axis so as to transmit a polarised reflected light beam, the reflected light beam resulting from the reflection of the polarised incident light beam by the surface (100) of the part, and
obtaining an image representative of reflections on the surface of the part,
determining whether at least one area of the image has a luminous intensity greater than a predefined threshold, said area of the image being referred to as “light area”,
detecting a defect when at least one light area of the image satisfies a predefined geometric criterion.

2. A control process according to claim 1, in which the predefined geometric criterion comprises the light area comprising an extent greater than a predefined value.

3. A control process according to claim 2, in which the predefined value is equal to 100 μm.

4. A control process according to claim 1, in which the predefined geometric criterion comprises the light area having a surface larger than a predefined area.

5. A control process according to claim 1, furthermore comprising recording the image of the surface of the part obtained, and transmitting said image of the surface to a processing device comprising electronic circuitry configured to implement the steps of determining whether at least one area of the image has a luminous intensity greater than a predefined threshold and detecting a defect when at least one light area of the image satisfies a predefined geometric criterion.

6. An optical inspection system intended for inspecting the quality of a part formed of a material comprising a non-birefringent major phase, the optical inspection system being configured to analyse parts having a birefringent major phase, the optical inspection system being intended to determine whether the material comprises at least one birefringent minor phase representative of a defect, the optical inspection system comprising:
a light source configured to emit an incident light beam in the direction of a surface of the part to be inspected,
a polariser configured to linearly polarise the incident light beam along a first polarisation axis so as to transmit a polarised incident light beam onto the surface of the part to be inspected,
a second polariser, referred to as “analyser”, configured to linearly polarise a reflected light beam along a second polarisation axis oriented perpendicularly to the first polarisation axis so as to transmit a polarised reflected light beam, the reflected light beam resulting from the reflection of the polarised incident light beam by the surface of the part,
an optical device for forming an image representative of reflections on the surface of the part, and
circuitry configured for:
determining whether at least one area of the image has a luminous intensity greater than a predefined threshold, referred to as “light area”, and
detecting a defect when at least one light area of the image satisfies a predefined geometric criterion.

7. An optical inspection system according to claim 6, in which the defect is a defect of freckle type.

8. An optical inspection system according to claim 6, in which the minor phase representative of a defect is an η phase, a μphase, a σ phase, a Laves phase and/or a boride.
